(19) United States
(12) Patent Application Publication
(10) Pub. No.: US 2025/0327557 A1
(43) Pub. Date: Oct. 23, 2025

(54) Light System Including A Lens And Housing That Are Removably Resealable

(71) Applicant: Valeo Vision, Bobigny (FR)

(72) Inventors: Robert Fraizer, Auburn Hills, MI (US); Don Hodnett, Troy, MI (US); Mark Singleton, Auburn Hills, MI (US); Scott Adaska, Troy, MI (US)

(21) Appl. No.: 18/643,089

(22) Filed: Apr. 23, 2024

(51) Int. Cl. F21S 45/50

(52) U.S. Cl. CPC F21S 45/50

(57) ABSTRACT

A light system comprising: a first body component; a second body component connected to the first body component forming a connection region; an interior space located between the first body component and the second body component; and one or more fasteners located within the connection region to connect the first body component to the second body component; wherein at least one of the one or more fasteners is a seal with a tackiness and the seal extends between and connects the first body component and the second body component together so that debris, fluids, or both are prevented from entering the light system.

### FIELD

The present teachings relate to a light system that includes two components that are removably connectable together so that internal components may be accessed and then resealed.

### BACKGROUND

Vehicles include many different types of lights and light systems. Some types of light systems included on a vehicle are low beam headlights, high beam headlights, taillights, turn signal lights, fog lights, running lights, or a combination thereof. Each of these light systems include one or more lights that extend out of an outer surface of a vehicle so that they provide light for the driver, passengers, pedestrians, or provide notice to surrounding drivers. These light systems generally direct light outward from the vehicle. These lights may include a reflector that spreads the light across a predetermined region. These reflectors may be made by injection molding.

Thus, there is a need for a light system that may be opened and resealed after the light system if fixed and/or maintained. There is a need for a light system where a lens may be sealed and resealed a plurality of times. There is a need for a material that maintains tackiness and sealing abilities over time such that the light system may be opened to fix all or a portion of the light system. It would be desirable to have a light system that may be disassembled so that some or all of the components may be removed, recycled, reused, accessed, or a combination thereof.

### SUMMARY

The present teachings provide: a light system comprising: a first body component; a second body component connected to the first body component forming a connection region; an interior space located between the first body component and the second body component; and one or more fasteners located within the connection region to connect the first body component to the second body component; wherein at least one of the one or more fasteners is a seal with a tackiness and the seal extends between and connects the first body component and the second body component together so that debris, fluids, or both are prevented from entering the light system.

The present teachings provide: a light system comprising: a first body component; a second body component connected to the first body component forming a connection region; an interior space located between the first body component and the second body component; one or more fasteners located within the connection region to connect the first body component to the second body component; and one or more indicating materials covering all or a portion of the connection region so that when the connection between the first component and the second component is removed the one or more indicating materials provide an indication.

The present teachings provide a light system that may be opened and resealed after the light system if fixed and/or maintained. The present teachings provide a light system where a lens may be sealed and resealed a plurality of times. The present teachings provide a material that maintains tackiness and sealing abilities over time such that the light system may be opened to fix all or a portion of the light system. The present teachings provide a light system may be disassembled so that some or all of the components may be removed, recycled, reused, accessed, or a combination thereof.

### BRIEF DESCRIPTION OF THE DRAWINGS

FIG. 1 is a side view of a vehicle including a light system.

FIG. 2A is an isometric view of a light system.

FIG. 2B is a cross-sectional view of the light system of FIG. 2A along line IIB-IIB.

FIG. 2C is a close-up view of a connection region of FIG. 2A at location IIC.

FIG. 2D is a close-up view of a connection region of FIG. 2A at location IID.

FIG. 3 is a cross-sectional view of two components connected together.

FIG. 4 is a cross-sectional view of connection region connected together with a fastener.

FIG. 5 is a cross-sectional view of a connection region locking two components together.

FIG. 6 is a cross-sectional view of a connection region directly connecting two components together.

### DETAILED DESCRIPTION

The explanations and illustrations presented herein are intended to acquaint others skilled in the art with the invention, its principles, and its practical application. Those skilled in the art may adapt and apply the invention in its numerous forms, as may be best suited to the requirements of a particular use. Accordingly, the specific embodiments of the present invention as set forth are not intended as being exhaustive or limiting of the teachings. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

The present teachings relate to a light system. The light system is located within a vehicle. Preferably, the light system is part of a vehicle such as a car, motorcycle, bus, truck, semi-truck, SUV, XUV, four-wheeler, dirt bike, tractor, combine, heavy equipment, farm equipment, industrial equipment, commercial equipment, or a combination thereof. The light system may project light in a forward direction, rear direction, side direction, vertical direction (e.g., z-axis), from a fore to an aft, an aft to a fore, or a combination thereof. Preferably, the light system projects a light from an external surface of the vehicle to a location in front of the vehicle or at an angle relative to the front or rear of a vehicle.

The light system may direct some light at the ground. The light system may direct some light above the ground. The light system may be integrated into a front end, a rear end, or both of a car. The light system may be an assembly. The light system may be a sealed light system that is integrated into a vehicle. The light system may be permanently sealed. Preferably, the light system may be removably sealed so that the light system may be opened and then resealed. The light system may be closed by one or more fasteners. The one or more fasteners may assist in preventing fluid from entering the light system. The fasteners include a seal that assists in closing all or a portion of the light system. The seal in the light system may form a soft seal (e.g., a seal that is removable without damaging the components). The seal (e.g., sealing material) may be removed without added chemicals, mechanical devices, damaging the components, or a combination thereof. The light system may be closed and individual components within the light system may sealed such that when fluid and/or debris enter into the light system, the individual components prevent fluid and/or debris from entering. The seal may extend in a recess and then another component may extend into the recess and compress the seal so that the seal extends around all or a portion of the two components. The seal may be located on one or more planar surfaces. The seals may prevent fluid, debris, contaminants, or a combination thereof from entering the light system, an interior space, or both. The seals may form an air tight connection or an air tight seal. The seal may form some level of connection with virtually any surface of a light system. The seal may connect to porous surfaces, smooth surfaces, recessed surfaced, textured surfaces, treated surfaces, surfaces that are made of one or more of the materials discussed herein, or a combination thereof. The light system may be opened so that one or more components inside of the light system may be replaced, repaired, recovered, remanufactured, or a combination thereof. The light systems may be retroactively changed to include the fasteners and fasteners configured as a sealing material. Thus, the fasteners and fasteners configured as a sealing material may be added to existing light systems. The light system may be opened and then resealed without adding any other additional components. Stated another way, the light system may be resealed using only original components that were present before the light system was opened. For example, a seal may extend between a housing (e.g., body) and a lens and the seal may assist in resealing the housing and the lens so that the seal located between the housing and fixedly connect the housing and the lens together. The fastener configured as a seal may assist in closing the light system and may close the light system along with other fasteners.

The light system may be a sub-assembly that is included in a larger light system. The light system may be integrated into another light system and may function to be part of the light system. The light system may project light out of the vehicle. The light system may include multiple different lights or light sub-systems that each provide a different function. The light systems may be multiple light systems or light sources stacked one above the other, side by side, within different planes, within a same plane and projecting in different direction, integrated into a single light system, or a combination thereof. The light system may have multiple smaller light systems or light sources. The light systems may include a body and the body may be covered by one or more outer lenses or may be free of an outer lens.

The outer lens may form an outer most surface of the light system. The outer lens may function to protect all or a portion of the light system. The outer lens may be a portion of the light system that prevents fluid, debris, or both from entering the light system. The outer lens may be free of a covering of a lighting component. The outer lens may cover the lights.

The plurality of light systems or lights may be located in one light system or one or more components. The plurality of light systems may operate independently of one another such that one light system may not affect another light system or portion of the light system. The light system may provide light with two or more colors, three or more colors, four or more colors, or a combination thereof.

The light sources function to produce light, direct light towards a base component such as a reflector, or both. The light source may be a device or a plurality of devices that create light and the light extends outward from the light source. The light source may produce a high beam, a low beam, a blending beam, a running light, a daytime light, a turn signal, a brake light, a warning light, a communication, ornamentation, a signal, decoration, or a combination thereof. The light sources may have different functions. For example, one light source may provide a running light, another light source may be a turn signal, and another light source may provide a high beam or a low beam. The light source may comprise a plurality of lights or may be a single light source within a set of light sources. The plurality of lights may be in one set or group of light sources. The light source may be a single light that projects light. In another example, a light source may direct light in a first direction. The light sources may direct light in a first direction. The base component may direct light from the light sources in a second direction.

The light sources may be any type of lighting device that produces light such as an incandescent bulb, fluorescent light, compact fluorescent lamp, halogen lamp, light emitting diode (LED), high intensity discharge lamps (HID); halogen lights, xenon lights, a laser diode, phosphorous bulb, or a combination thereof. The light sources may be a single lamp or bulb. Preferably, the light sources are part of a set of light sources that include a plurality of lamps, bulbs, diodes, or a combination thereof. The light sources may be part of a set of light sources that includes 2 or more, 3 or more, 4 or more, 5 more, 7 or more, 9 or more, or 11 or more lights that produce light and combine together to form the light extending from the light system. The sets of light sources may include 20 or less, 18 or less, 16 or less, or 14 or less lights that produce light (e.g., each set may include 8 light sources or alternatively all of the sets when combined together may include 8 light sources or 2 light sources). For example, the set of light sources may be the contents of a single printed circuit board that perform a same lighting function and the set of light sources may be 8 lights.

The number of light sources in a part of the light system may dependent upon a size of the region to be illuminated or an amount of light to be provided. Thus, the light source may be one or more lights, two or more lights, or three or more lights. The light source may be static. The light sources may be free of movement. The light source may be fixed. The light sources may be static and may be manually or physically adjusted so that the light sources are directed to a desired location. The light sources may be fixed and the light from the light source may be moved, bent, directed, or a combination thereof by optical elements, textured portions, micro-optics, or reflectors (e.g., a substrate or a portion of a substrate). Each device (e.g., light or LED) of the light source may be turned on and off. The light sources may be illuminated in a sequence. The light source may be located within a light system at a location relative to a substrate, an edge of a substrate, a side of a substrate, or a combination thereof. The light sources may work together as a set of light sources to create light. All of the light sources may be a same color or provide a same color light. For example, all of the lights may be white or non-colored light. All of the light sources may be a single color light source.

The set of light sources function to fill a light bar, a lens, an outer housing, an outer lens, light blade, a substrate, an edge of a substrate, a side of a substrate, a reflector, a base component, or a combination thereof so that light projected outward to perform some function. The light sources may cause all or a portion of a light system to glow. For example, a light bar or les may glow when contacted with light from a light source. The set of light sources may be a single function (e.g., a high beam, a low beam, a blending beam, a running light, a daytime light, a turn signal, a brake light, ornamentation, a display, signaling, or a combination thereof). Each set of light sources may perform a single function. The light sources may extend in a row, in a column, a straight line, or a combination of both. The light from the light sources may be directed outward from a vehicle so that the light is visible external of the vehicle. The light sources may be controlled my one or more controllers.

The controllers function to control the light sources or the lights within a light source individually. The controller may be part of the vehicle, part of the light system, or both. A single controller may control all of the lights. The controller may illuminate (e.g., fire) the lights in a sequence, individually, in a pattern, a predetermined manner, a predetermined sequence, randomly, or a combination thereof. The controller may be programmable, include pre-set programs, or both. The controller may be accessed inside of the vehicle so that the user can change the illumination settings of the light system. The controller may communicate with light sources through one or more printed circuit boards.

The light sources may be located on or connected to one or more printed circuit boards. The printed circuit boards (PCB) may provide power, signals, support, or a combination thereof to one or more light sources. The PCB may be fixed within a light system. Each PCB may be connected to a plurality of light sources. The PCB may be electrically connected, mechanically connected, or both to one or more light sources discussed herein, the base component, or both. The PCBs may aim the light from the light sources towards a portion of a base component. The PCBs may align light sources with base components, reflectors, or both. The PCBs may be connected to a base component (e.g., a body) of the light system.

The base component (e.g., housing, frame, body, lens, a cover, a support bracket, a bezel) of the light system functions to connect the light system within a vehicle, connect a lens within the light system, or both. The base component includes and/or houses one or more light sources, two or more light sources, three or more light sources, a plurality of light sources, electronics, harnesses, or a combination thereof. The base component may house lights to direct light in a predetermined direction, redirect light in a predetermined direction, or both. The base component may aim the lights within the light system, the vehicle, or both. The base component may be a central portion that all of the components connect to so that the light system when connected to a vehicle the light system functions. The base component may be directly connected to a printed circuit board, a controller, a micro-processor, or a combination thereof. The base component may be thermally connected to a printed circuit board, a controller, components on the printed circuit board, or a combination thereof. The printed circuit board, the controller, the light sources, or a combination thereof may be connected to the body. The printed circuit board, the controller, the light sources, the reflectors, any other component located between a base component and a lens, or a combination thereof (e.g., hereinafter referred to as internal componentry).

The internal componentry may be located internal to the light system between a base component and a lens. The internal componentry may be located between the base component and the lenses. The internal componentry may be free of any sealing. For example, the internal component may be sealed by being located within the interior space. The internal componentry may be sealed individually. The base component and the lenses may be connected by one or more fasteners.

The fasteners function to removably connect two or more components together so that the base component, the lenses, or both are prevented from being removed. The fasteners may form a connection in a connection region. The fasteners may constrain two parts relative to one another. The fasteners may be seals, made of a sealing material, or both.

The fasteners when configured as seals may be free of a permanent chemical bond. The seals may be a non-cured soft material. The seals may be free of a cure time. The fasteners when configured as seals may create a temporary chemical bond. For example, the seal may be releasable connected from one or more components. The seals may create a first level of fastening. The seals may create a removable fastening. A first fastener (e.g., seal) may be proved with a second fastener (e.g., a rivet or screw) so that a connection may be formed. The seals function to removably connect two or more components together. The one or more seals may assist in connecting two components together. The one or more fasteners when configured as seals may be tacky, malleable, amorphous, plastically deformable, elastically deformable, hydrophobic, or a combination thereof such that the one or more seals assist in connecting the two or more components together. The seals may be non-hardening, removable, low tack, disposable, pliable, formable, low energy curing, non-curing, thermally resistant, removable, reusable, non-bonding, free of pretreatment, or a combination thereof. The seals may be free of any tackiness. The sealing material may be a or include rubber, an elastomer, a polymer, or a combination thereof. The sealing material may be an O-ring. The one or more seals may not form a permanent connection. The one or more seals may not be or may be free of an adhesive, a glue, an epoxy, a liquid, a curable material, chemical bonds, chemical bonds with other components (e.g., a lens or a body composition), or a combination thereof. The one or more seals may only be needed to connect the two or more components together. For example, the seals may connect a lens and a body component together (e.g., within a connection region). The seals may be made of a compressible material.

The one or more seals may be sandwiched between the two or more components and the two or more components may form a connection or one or more fasteners may connect the two or more components together. The one or more seals when compressed may extend around the two or more components. The one or more seals may maintain material characteristics regardless of an amount of compress, shear forces, temperatures (e.g., hot or cold), or a combination thereof. The seals may resist movement of fluids from a location external of the light system to a location internal of the light system. The seals may be hydrophobic. The seals may resist fluid penetration. The seals may prevent fluid, debris, or both from passing into the light system. The seals may be a soft tack material, a synthetic block copolymer, a hot melt, a pressure sensitive adhesive, or a combination thereof. The seals (e.g., sealing material) may be made of or include a block copolymer, a styrene block copolymer (SBC), a styrene-isoprene-styrene (SIS), a styrene-butadiene-styrene (SBS), acrylic block copolymers (ABC), or a combination thereof. The seals may include a rubber polymer, a natural rubber, butyl rubber, a nitrile rubber, or a combination thereof. The seal may be made of or include polyisoprene (PI), polybutadiene, polyethylene (PE), polyethylene-propylene (PP), polyethylene-butylene, or a combination thereof. The seals may form a connection that may be removable. The seals may form a connection that may be removed and then reconnected. The seals may have a tackiness such that the seals assist in holding two or more components together, release the two or more components, and then reconnect the two or more components together.

The one or more seals may have a tackiness. The one or more seals may have a tackiness so that if/when the two or more components move relative to one another the one or more seals move with and maintain a connection with each of the two or more components. For example, if the two or more components thermally expand and/or contract the seals may move with a portion of the two or more components a portion of the seals connect to such that the seal moves with the component. The one or more seals may have a sufficient tackiness to hold two components together. The tackiness may prevent or resist the two or more components from being removed or moved in a direction substantially normal to one another (e.g., one component moved in a direction perpendicular to the other component). The tackiness of the seal may hold a first component relative to a second component and the seal itself may prevent items (e.g., fluid and/or debris) from passing between the two components. The tackiness may prevent or resist the two or more components from being removed or moved parallel to one another (e.g., sheared apart). The one or more seals may have a sufficient tackiness to prevent fluid from passing between the first body component and the second body component in the connection regions, or both.

The seals may have a tackiness so that the one or more seals resist a force against the two or more components being moved apart of about 0.5 Kg or more, about 1 Kg or more, about 2 Kg or more, about 3 Kg or more, about 5 Kg or more. The tackiness may resist a force of about 50 Kg or less, about 40 Kg or less, about 30 Kg or less, about 20 Kg or less, about 10 Kg or less, or about 7 Kg or less. The one or more seals may maintain tackiness over time. Tackiness of the one or more seals may resist movement of the two or more components relative to one another. The fasteners when configured as seals may be provided with fasteners of a different configuration and may connect two or more components together. The light system may include individual components that may be sealed, with or without the sealing material, and the housing may be free of sealing material.

The fasteners may be part of one or both of the components. The fasteners may be a monolithic part of the body components. The fasteners may be a discrete part that assists in connecting two components together. The fasteners function to connect two or more body components together and prevent the body components from being disconnected. The fasteners may form a connection in one or more connection regions. The fasteners may assist in sandwiching the seal(s) between the two components. The fasteners may be part of a clam shell design where at least a body component and a lens connect together to form an interior space. The fasteners may be a snap that connects the lens and the base component together. The fasteners may be part of a lens and part of a body component. For example, a first fastener may be a male part on a body component and a second fastener may be a female part on a lens that connects to the first part so that a sealed system is formed, or vice versa (e.g., to form a connection in a connection region). The fasteners may be threaded members, hooks, a lip, a hook and lip, a snap, opposing hooks, a hook and spring-loaded member, a clip, screws, clamps, interlocking members, mated members, or a combination thereof. The fasteners may be fixedly connected. For example, the fasteners may connect two or more components together but may not be removed without damaging the fasteners. The fasteners may be removably connected. For example, the fasteners may be disconnected, the internal componentry accessed, and then the fasteners re-installed to reconnect the two or more components together. The fasteners, the seals, or both may be removable such that the light system may be opened and then subsequently reclosed. The fasteners may be used with or may be a cover.

The cover may extend between two or more body components. The cover may assist in connecting the two components, preventing fluids from extending between the two or more components, or both. The cover may be a polymer that forms to one or more components. The cover may assist in retaining the sealing material. The cover may be made of the BMC material discussed herein. The cover may support the components. The cover may form a skeleton. The cover may be a vacuum formed cover that may lock onto one or more components. The cover may reduce a weight of the light system (compared to a light system made entirely of a body component material. The cover may be physically connected to the sealing material, a lock (e.g., tab, hook, lock) of the body component, or both. The cover may only structurally reinforce the body component. The fasteners, seals, cover, or a combination thereof may facilitate opening the light system without cutting or breaking any components of the light system. The fasteners, the seals, covers, or a combination thereof may be removed without cutting, breaking, deforming, or a combination thereof so that the fasteners, the seals, covers, or a combination thereof may be reconnected to re-seal the light system. The fasteners, the seals, the two or more components, the covers, or a combination thereof may be covered entirely or completely with an indicating material. All or a portion of the covers may be an indicating material or act as an indicating material. For example, the cover may be removed before the first component and second component may be opened such that there is an indication that the light system has been opened or accessed.

The indicating material may function to indicate that the light system was opened or attempted to be opened. The indicating material may indicate that one component was moved relative to another component. The indicating material may be a component of the light system that is physically damaged, broken, changes, or a combination thereof when an interior of the light system is accessed. The indicating material may indicate that one or more fasteners were accessed, moved, or a combination thereof. The indicating material may indicate that the light system was opened, the internal components were accessed, or both. The indicating material may tear, deform, change colors, change shapes, indicate tampering, indicate that tooling was applied to the fasteners, the two or more components were moved relative to one another, or a combination thereof. The indicating material may fasten a cover, be fastened by a cover, or both. The indicating material may be located over all or a portion of an outer lens, a cover, or both. The indicating material may be a shrink wrap that extends over the outer lens, the cover, or both. The indicating material may partially or completely destroyed when an interior of the light system is accessed. For example, the indicating material may need to be completely removed in order to access the interior of the light system. A portion of the indicating material may be removed and a portion of the indicating material may be retained on the light system when the interior of the light system is accessed. For example, in order to access the interior components of the light system, located in an interior space, at least a portion of the indicating material may need to be removed and at least a portion of the indicating material may be retained so that the retained indicating material indicates that the light system was opened. For example, the indicating material may provide an alert that a lens is removed from a base component. The indicating material may include an indicating lock.

The indicating lock may connect the indicating material to a portion of one or more base components so that if the base components are moved the indicating lock may move and the indicating material may indicate that an interior space has been accessed. For example, once a connection is formed between a component and the indicating lock, the connection may only be broken by destroying all or a portion of the indicating material. The indicating lock may include a through hole that all or a portion of a hook, tab, lock, or a combination thereof extend through. The indicating lock may extending into a fastener. The indicating lock may be connected to a fastener. The indicating lock may extend around or connect to a cover lip, a lens lip, or both. The indicting lock may be a portion of the indicating material that is positioned between two base components so that when the base components are moved to access an interior space an indication is provided that the interior space was accessed. The indication may be a change in color, change in space, being broken, falling off, deforming, or a combination thereof. The indicating lock may extend into or into contact with a fastener and the tackiness of the fastener may form a connection with the indicating lock. Thus, when the two or more base components are disconnected the indicating material will indicate that the interior space has been accessed via moving the base components relative to one another.

The base component may be one or more exterior parts of a light system. The base component may be a cover, a lens, an outer housing, all or part of a clam shell, or a combination thereof. A cover may be a base component that assists in forming an exterior of the light system. The cover may seal or form a portion of the interior space. The cover may connect to a body component, a lens, or both to form all or a portion of an exterior of a light system. The base component may be partially or entirely opaque. The base component may be partially or entirely transparent. The base component may be one or more monolithic pieces. The base component may have at least a first portion and a second portion. Each part of the base component may include a lip.

The lip may extend outward from a portion of a base component. The lip may be a part that connects a first base component to a second base component. The lip may be a base component lip, a cover lip, a lens lip, or a combination thereof. The lip may extend outward from a main portion of the base component. The lip may be in contact with one or more fasteners. The lips may extend outward from the base component. The lips may extend cantilever. The lips may extend parallel to another lip, another base component, or both. A lip of a first base component may extend through a lip of a second base component. The lip may form a portion of a fastener.

The lip may be or include a tab, a hook, or a projection. The tab may be straight, curved, arced, a one-way insertion device, triangular, or a combination thereof. That tab may prevent removal of all a clip, a fastener, or both. The tab may be monostable. The tab may self-bias to a locked position. The tab may hold a portion of the light system in a locked state. The tab may prevent axial movement, removable, unlocking, or a combination thereof. The tab may be an outward projecting part of a body component, a clip, or both. The tab may connect one body component to another body component. The tab may allow movement in a first direction and prevent movement in a second direction. The tab may be any device that allow for movmeent of a part of the light system in a first direction and prevents movement of any device in a second direction (e.g., a body component, cover, outer lens, lens, cover indicating material). The tabs may form a connection my extending through a recess, partially into a recess, holding onto a portion of the light system, or a combination thereof. The tab may be located adjacent to or opposite to a hook.

The hooks may function to connect two or more parts of the light system together. The hooks may prevent one or more parts of the light system from being moved, removed, or both. The hooks may assist in forming a locked connection. The hooks may connect one device to another device. The hooks may connect to a tab, projection, recess, lock, indicating lock, or a combination thereof. The hooks may curve inward. The hooks may curve upward. The hooks may extend inward. The hooks may create a holding force. The hooks may have an “L” shape, a “J” shape, a “U” shape, or a combination thereof. The hook may receive all or a portion of a tab, a lock, a recess, a projection, or a combination thereof. The hooks may extend from a projection, be part of a projection, connect a projection of one base component to another base component, or a combination thereof.

The projection may function to extend outwardly. The projection may be a part a device or a body component that extends outward. The projections may extend through a recess. The projections may extend outward and may include a tab, a hook, a lock, or a combination thereof of an end of the projection. The projections may be an outward extending portion of a base component. The projections of a first base component may extend through a recess of a second base component. The projections may be substantially straight. The projections may extend outward and terminate with a tab, hook. lock, or a combination thereof.

The lock may extend through a recess and prevent movement of all or a portion of a component of the light system from moving in a second direction (e.g., a removal direction). The lock may hook one or both sides of a recess. The lock may be a Christmas tree connector. The lock may have an angled portion to facilitate movement through a recess. The lock may have a locking position to prevent movement through the recess. The lock portion may be flat to prevent the lock from being moved backwards. The lock may have a size that is substantially a same size as a recess so that the lock fits through the recess in a first direction and then is prevents from moving in a second opposing direction. The lock may form a connection with an indicating lock (e.g., a recess or recess of indicating material).

The recess functions to allow all or a portion of a base component to extend therethrough. The recess functions to connect two components together. The recess functions to allow a portion of a base component (e.g., a cover or a lens) to move in a first direction and to be prevented from moving in a second direction. The recesses may be a through hole. The recess may partially extend through a base component so that a tab, hook, or lock may form a connection with the recess. The recess may be round, square, rectangular, oval, or a combination thereof. The recess may mirror a shape of a lock, tab, hook, projection, or a combination thereof.

The lock, the recess, or both may be part of a clip, a base component, or both.

The clip may be a base component. The clip may function to connect to or more base components together. The clip may be made of different materials than the body components. The clip may be made of a biasing material. The clip may be made of or include materials that a spring steel, elastic, elastomeric, rubber nitinol, or a combination thereof. The clip may removably connect two base components together. The clip may have a “C” shape, a “U” shape, an “O” shape, or a combination thereof. The clip may be a cotter pin, a screw, a fastener, a pin, some other device that removably connects two components together, or a combination thereof. The clip may connect two base components together.

The base component may include a reflector so that the base component reflects light, aims light, dissipates heat, or a combination thereof. The base component may include a reflector portion, a heat sink portion, a heat dissipation portion, a projector, lidar, radar, modules, or a combination thereof. The base component may be a reflector a part of the housing, a support bracket, a connection bracket, a substrate of a reflector, a part of a reflector previously made of metal, or a combination thereof.

The base component may have a body composition (e.g., composition) that may be made of or include a first composition of materials and the body component may be covered one or more coatings. The body composition may be sufficiently rigid to support the light system within a vehicle. The body composition may be sufficiently thermally conductive to dissipate heat to prevent thermal movement of the light system (e.g., movement from thermally expanding or thermally contracting). The body component has a body composition that may be or include one or more components.

The body composition of the base component may include one or more bulk molded compounds (hereinafter BMC). The body composition may be comprised substantially of BMC. The body composition may be composed of about 40 percent or more, about 50 percent or more, about 60 percent or more, about 70 percent or more, about 80 percent or more, about 90 percent or more, or about 95 percent or more BMC of the total weight of the base component. The body composition may be composed of about 99 percent or less, about 98 or less, 97 percent or less, 95 percent or less, about 93 percent or less, or about 90 percent or less of the total weight of the base component. The BMC may include glass fibers, styrene, an initiator, a shrink additive, inhibitors, a filler, a thermoset resin, calcium carbonate (CaCO₃), crushed glass, binder, polyester, recycled material, post-industrial recycled material, post-consumer recycled material, polymethyl methacrylate (PMMA), talcum powder, magnesium silicide (Mg₂Si), thermoset resin, unsaturated resin, release agent, catalyst, filler, reinforcement, thermoplastic resin, pigment, thickening agents, flash reducer, or a combination thereof.

The glass may be a recycled glass, The glass may be post-industrial, post-consumer, or both. The glass may be recycled in a similar manner as the other recycled materials (e.g., reduced in size, classified, and added to the body composition). The glass may assist in reducing roughness of the base component. The glass may be added as a filler. The glass may be added into the resin.

The thermoset resin may be or include polyester, an unsaturated polyester, vinyl ester, epoxy, phenolic, or a combination thereof. The thermoset may react when cured to solidify the BMC. The thermoset resin may be about 3 percent or more, about 5 percent or more, about 7 percent or more, about 10 percent or more, or about 12 percent or more of the total weight of the base component (e.g., around 7 percent by weight). The thermoset may be about 30 percent or less, about 25 percent or less, about 20 percent or less, about 15 percent or less, about 13 percent or less, or about 35 percent or less of the total weight of the base component. The thermoset resin may be combined with filler, reinforcement, thermoplastic resin, or a combination thereof.

The resin may be one or more and preferably two or more different resins. The resins may be two different polyesters. The resins may be a BMC resin and a PMMA resin. The resins may have different bonding levels, different bonding timing, different bonding strengths, or a combination thereof. The different resins may provide different properties to the base component. The two or more resins may be added with inhibitors.

The inhibitors may be a free radical inhibitor. The inhibitors may delay a reaction of q free-radical catalyst during injection into a mold. The inhibitors may be or include methyl ethyl ketone peroxide (MEKP), hydroquinone, 4,4-dihydroxybiphenyl, catechols, 3-n-alkyl, 3-isopropyl, 3-phenyl, 4-n-alkyl, 4-isopropyl, 3,5dialkyl, 3,6-dialkyl, hdroxylamines, p-phenylenediamines, ninitro-ortho-cresol, di-nitro-sec-butylphenol, 2,6-Di-tert-butyl-p-cresol, 4-methoxyphenol, 4-tert-butylpyrocatechol, tert-butylhydroquinone, 2-tert-butyl-1,4-benzoquinone, copper (II) Dibtyldithiocarbamate, 2,6-Di-tert-butylphenol, 2-[1-(Hydroxy-3,5-di-tert-pentylphenyl)ethyl]-4,6-di-tert-pentylphenyl Acrylate, phenothiazine, 1,1-Diphenyl-2-picrylhydrazyul free radical, 1,4-Benzoquinone, 6-tert-butyl-2, 4-xylenol, or a combination thereof.

The inhibitors function to prevent curing the resins before the resins are moved to a desired location. The inhibitors may partially inhibit curing. The inhibitors may completely prevent curing. The inhibitors may prevent curing until the resins achieve a predetermined temperature. The inhibitors may be a BMC inhibitor. The inhibitors may prevent curing when the body composition (including the resins) are being added to the mold. The inhibitors may be or include catechols with 3-n-alkyl, 3-isopropyl, 3-phenyl, 4-n-alkyl, 4-isopropyl; or a combination thereof. The inhibitors may prevent resins from curing until a temperature is achieved, a curing mechanism is introduced (e.g., temperature, moisture, UV. Time, curing component). The one or more inhibitors may be used with one or more fillers.

The filler functions to enhance thermal conductivity, create a complete component, or both of the BMC. The filler may have a high surface area that fills voids between thermoset resin, reinforcement, thermoplastic resin, or a combination thereof. The filler may be calcium carbonate, talcum powder, barium sulfate, sodium sulfate, magnesium silicate, mica, kaolin, calcium silicate, recycled BMC, or a combination thereof. The filler may be inert. The filler may be a mixture of fillers listed herein. The filler may be one of the fillers listed herein. The filler may be present in an amount of about 15 percent or more, about 25 percent or more, about 35 percent or more, about 45 percent or more, or about 55 percent or more by weight of the total weight of the base component. The filler may be present in an amount of about 80 percent or less, 75 percent or less, about 70 percent or less, or about 68 percent or less by weight of the total weight of the base component. The filler may be mixed with a reinforcement material, a mold release, a catalyst, or a combination thereof as part of the body composition of the base component.

The catalyst functions to start a reaction, drive a reaction, or both. The catalyst may vary depending on the resin being used (e.g., thermoplastic resin or thermoset resin). The catalyst may be or include ketone, cobalt, peroxyester, a methyl ethyl ketone peroxide (MEKP), vinyl ester, or a combination thereof. The catalyst may be present in an amount of about 0.2 percent or more, about 0.4 percent or more, about 0.6 percent or more, or about 0.8 percent or more by weight of the total weight of the body composition of the base component. The catalyst may be present in an amount of about 5 percent or less, about 3 percent or less, about 2 percent or less, or about 1 percent or less by weight of the total weight of the body composition of the base component.

The reinforcement may strengthen the thermoset resin, thermoplastic resin, filler, or a combination thereof. The reinforcement may be a synthetic material, a natural material, glass, fiberglass, cellulose, carbon fiber, metal fibers, or a combination thereof. The reinforcement may be fibers, chopped fibers, crushed fibers, chopped glass fibers, crushed glass, or a combination thereof. The reinforcement may be uniformly mixed within the body composition. The reinforcement may be mixed with binder before the reinforcement is added into the body composition.

The binder may function to connect all of the components of the BMC together. The binder may chemically or mechanically connect all of the components together. The binder may act as a glue. The binder may be a natural material, a synthetic material, ethylene vinyl acetate, styrene-butadiene, polyacrylamide, starch, rubber, polyester, or a combination thereof. The binder may be present in an amount of about 1 percent or more, about 2 percent or more, about 3 percent or more, about 4 percent or more, about 5 percent or more, or about 7 percent or more by weight of the total weight of the body composition of the base component. The binder may be present in an amount of about 20 percent or less, about 15 percent or less, about 10 percent or less, or about 8 percent or less by weight of the total weight of the body composition of the base component. The binder may be a thermoset resin. The binder may be added in addition to the thermoset resin discussed herein. The binder may be the thermoset resin discussed herein. The binder may be mixed with a thermoplastic resin.

The thermoplastic resin may prevent shrinkage. The thermoplastic resin may provide some flexibility in the body composition of the base component. The thermoplastic resin may be present in an amount of about 1 percent or more, about 3 percent or more or about 5 percent or more by weight of the total weight of the body composition of the base component. The thermoplastic resin may be present in an amount of about 15 percent or less, about 10 percent or less, about 7 percent or less, or about 6 percent or less by weight of the total weight of the body composition of the base component. The thermoplastic resin may be a polycarbonate, acetal copolymer polyoxymethylene, acetal homopolymer polyoxymethylene, acrylic, acrylic-polymethyl methacrylate (PMMA), nylon, polyethylene, polypropylene, polystyrene, polyvinyl chloride (PVC), polytetrafluoroethylene, polyvinyl acetate, saturated polyesters, or a combination thereof. The thermoplastic resin may be PMMA. The body composition may be a mixture of filler, reinforcement materials, thermal plastic resins, catalyst, release agents, unsaturated resin, or a combination thereof with thermally conductive components. The resin may virgin material, recycled material, or both.

The recycled material may be a cured thermoset. The recycled material may be BMC and PMMA. The recycled material may be only BMC or only PMMA. The recycled material may be a mixture of the BMC and the PMMA such that the total amount of recycled material is equal to the percentages discussed herein. The recycled material may replace filler material. The recycled material may reduce a specific gravity of the final body composition or final product. The recycled material may be added as a filer. The recycled material may have a lower specific gravity than a traditional filler (e.g., calcium, carbonate). The specific gravity of the recycled material at 23° C. may be about 0.5 or more, about 0.7 or more, about 0.9 or more, or about 1.1 or more. The specific gravity of the recycled material at 23° C. may be about 3.0 or less, about 2.5 or less, about 2.0 or less, about 1.7 or less, about 1.5 or less, about 1.3 or less (e.g., between about 1.1 and 1.5 (e.g., about 1.2)).

The recycled material may be dimensionally stable. The dimensional stability may rigidity of a material. The dimensional stability may prevent the material from warping, changing shape, expanding, contracting, changing size, or a combination thereof. The dimensional stability of the material may be such that the material does not change over time. For example, the material may maintain a shape so that the material does not increase or decrease in size as temperatures around the material changes.

The recycled material may be post-consumer material, post-industrial material, or both. The recycled material may be material that has been fully processed, cured, thermoset, or a combination thereof. The recycled material may be material that has been cured (e.g., is thermoset). The recycled material may be material that is permanently fixed. The recycled material may be resins that have been cured so that irreversible bonds are created inside of a body component. The recycled material may be material from before a coating is applied. The recycled material may be only material with the base component.

The recycled material may be processed before the recycled materials are added into the body composition of the body component. The recycled material may be processed by cutting, grinding, crushing, milling, ball milling, pulverizing, shredding, granulating, blending, grinding, regrinding, or a combination thereof. The recycled material may be screened, classified, sorted, or a combination thereof. The screening may remove particles above a certain size. The recycled material may be added in an amount of about 1 percent or more, 5 percent or more, 10 percent or more, or even 20 percent or of a total weight of the base component. The recycled material may be added in an amount of about 50 percent or less, about 40 percent or less, about 30 percent or less, or about 20 percent or less of a total weight of the base component. The recycled materials may be mixed into the body composition.

A coating may be directly applied to the base component. The coating may be reflective, thermally conductive, or both. The coating may be applied directly on the base component without any intervening components or base coatings. The coating may be applied to the base component without any basecoat. The coating may be directly applied to base component.

The present teachings provide a light system that may be opened and then resealed so that the light system may be placed back into operation. The light system may be opened, some parts reused and some parts recycled or discarded. Parts of the light system may be recycled or repurposed in another application due to the parts being broken, free of contaminants (e.g., glues, adhesives, cured material). A lens may be removed from the body component so that the lens, the body component, or both may be disconnected without damaging any of the components. One or more of the lenses, the body component, or both may be removed, remanufactured, opened, replaced, repurposed, or a combination thereof and then placed back into service.

The teachings herein create a lighting component with one or more base components that may be made by one of more steps taught herein. The lighting component may be virtually any part of the lighting system. The base components may be a reflector. The process may begin by forming an article of manufacture (e.g., a body). A base material may be mixed together. The base components may include a BMC. The body composition may be formed into a body component. The body composition material may be formed into a body by extrusion, pultruding, molding, compressing molding, melt molding, transfer molding, injection molding, vacuum forming, or a combination thereof. The body may be free of any post forming steps. The body may be free of any sanding, spraying, smoothing, surface treatment, or a combination thereof. The body may be free of flashing removal. The body may be moved directly from a forming step to coating. The coating may be applied directly on the base components. One or more masks may be applied to the base components before the coating is applied so that one or more areas may be free of the coating. The base components may be free of a base coat.

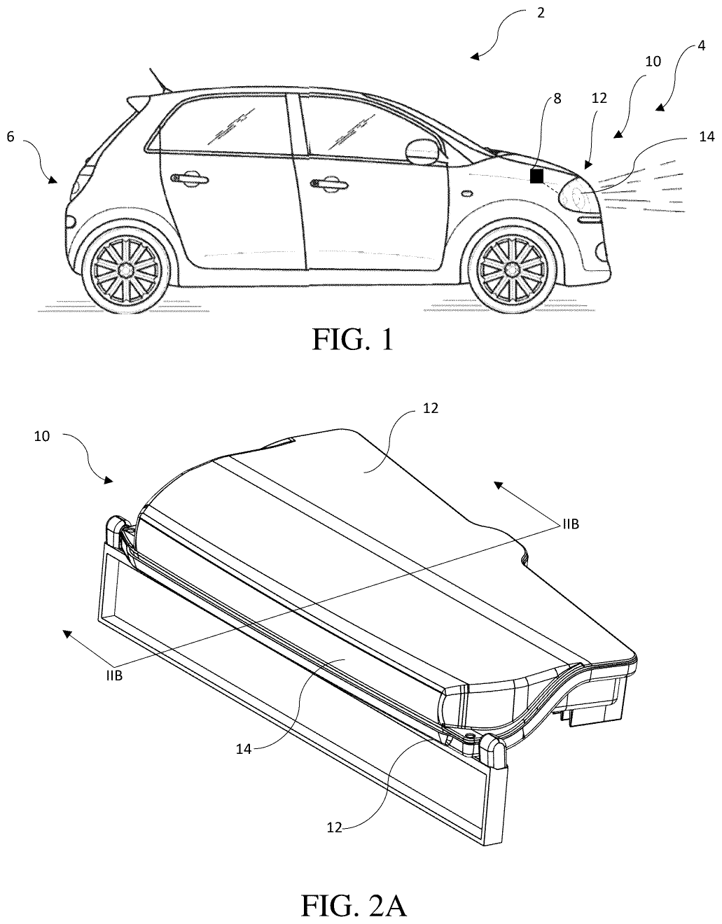

FIG. 1 illustrates a side view of a vehicle 2 including light systems 10. The light systems 10 provide light around the vehicle 2. The light systems 10 are located at a fore 4 end of the vehicle 2 but could be located at an aft 6 of the vehicle 2. The light systems 10 include a body 12 with an outer lens 14. The light systems 10 may be controlled by one or more controllers 8 jointly or individually.

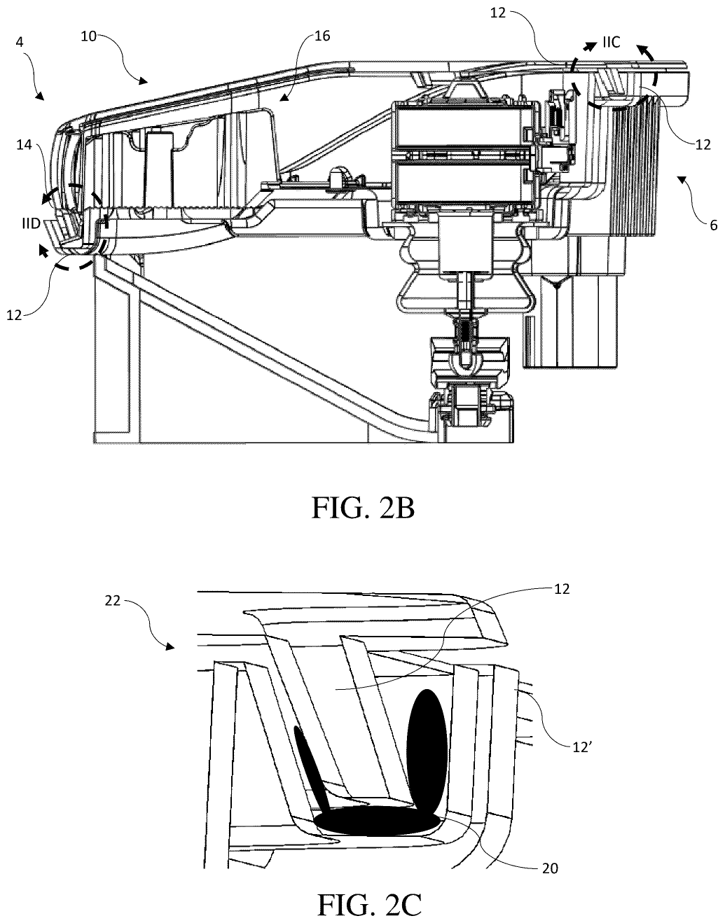

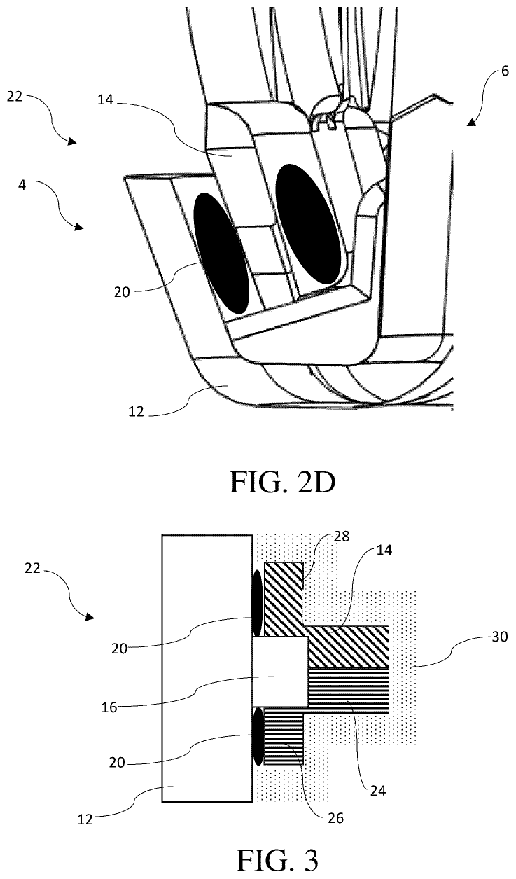

FIG. 2A is an isometric view of a light system 10 removed from a vehicle. The light system 10 includes a body component 12 connected to an outer lens 14 generate an interior space (not visible).

FIG. 2B is a cross-sectional view of the light system 10 of FIG. 2A along line IIB-IIB. A front end of the light system 10 includes a body component 12 connected to an outer lens 14. The rear end of the light system 10 includes a body component 12 connected to a body component 12 forming an interior space 16 between the front end and the rear end. The interior space 16 houses interior components 18 to generate light. The light system 10 has a fore 4 and an aft 6.

FIG. 2C is a close-up view of a connection region 22 of the cross-sectional view in FIG. 2B at IIC. The connection region 22 has a first body component 12 and a second body component 12′ connected together. A fastener 20 (e.g., sealing material) is located between the first body component 12 and the second body component 12′ to assist in forming a connection within the connection region 22. The fastener 20 may be a sealing material that has a tackiness that prevents the first body component 12 from moving relative to the second body component 12′. The fastener 20 seal an opening and may prevent fluid, debris, or both from extending through the connection region 22.

FIG. 2D is a close-up view of a connection region 22 of the cross-sectional view of FIG. 2B at IID. The connection region 22 includes an outer lens 14 that extends into a body component 12. The body component 12 is “U” shaped such that a portion of the body component 12 extends on a fore 4 side of the outer lens 14 and a portion of the body component 12 extends on an aft 6 side of the outer lens 14. A fastener 20 is located on the fore 4 side of the outer lens 14 and a fastener 20 is located on the aft 6 side of the outer lens 14 to seal and connect the body component 12 to the outer lens 14.

FIG. 3 is a cross-sectional view of a connection region 22. The connection region 22 is where a body component 12 connects to an outer lens 14 and a cover 24. The outer lens 14 includes a lens lip 28 that connects to the body component 12 by a fastener 20 illustrated as a sealing material. The cover 24 includes a cover lip 26 that connects to the body component 12 by a fastener 20. The outer lens 14 and the cover 24 may be one monolithic piece. The outer lens 14 and the cover 24 may be separate pieces that connect together. An interior space 16 may be formed between the outer lens 14 and cover 24 and the body component 12. The outer lens 14 and the cover 24 are fastened together and covered by an indicating material 30. The indicating material 30 may indicate when the outer lens 14, the cover 24, the body component 12 or a combination thereof are accessed such that the indicating material 30 demonstrates if the interior space 16 has been accessed. The indicating material 30 shrink wrap to the cover lip 26 and the lens lip 28 so that the indicating material 30 is damaged when the cover lip 26, the lens lip 28, or both are accessed.

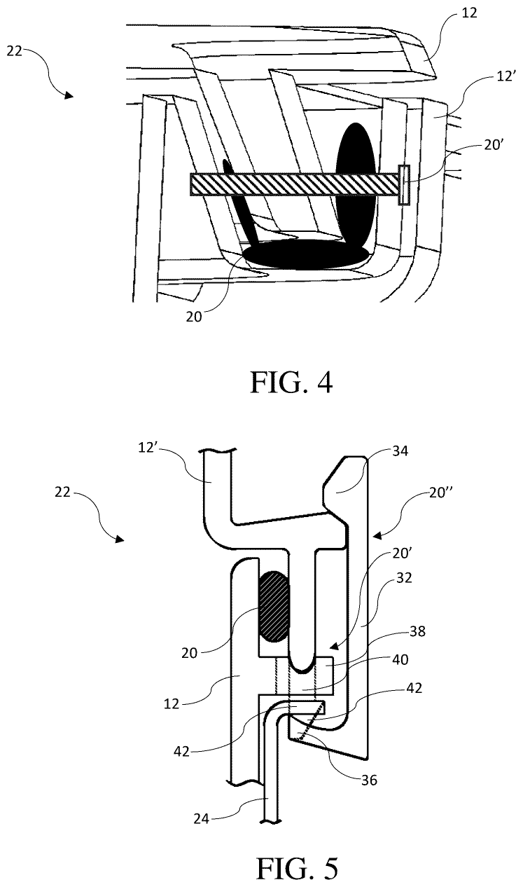

FIG. 4 is a connection region connected together with two fasteners 20 and 20′. The first fastener 20 is a sealing material that is located between a first body component 12 and a second body component 12′ to connect the two together. The second fastener 20′ extends through the second body component 12′ and into or through the first body component 12. The first fastener 20 may create a first holding force while the second fastener 20′ connects the first body component 12 to the second body component 12′.

FIG. 5 is a cross-sectional view of a connection region 22. The connection region 22 includes a first body component 12 and a second body component 12′ (one of which could be a lens or connected to a lens). A fastener 20 is located between the first body component 12 and the second body component 12′ to form a first level of sealing and connecting therebetween. The fastener 20 may provide a first holding strength or sealing between the first body component 12 and the second body component 12′.

The first body component 12 includes a projection 38 with a recess 40 extending therethrough. The second body component 12′ includes a lock 42 that extends through the recess 40 in the projection 38 to connect the first body component 12 to the second body component 12′.

An cover 24 extends between the first body component 12 and the second body component 12′. The cover 24 includes a cover lip 26 that connects to the cover 24 to the lock 42. The lock 42 may prevent the second body component 12′ from being removed from the recess 40 without the lock 42 being biased. The lock 42 may be monostable so that the lock maintains itself in the recess 40 without a biasing force aligning the lock 42 with the recess 40.

A clip 32 extends from a top of the second body component 12′ to the lock 42 of the second body component 12′. The clip 32 includes a tab 34 that connects to a first portion of the second body component 12′ and a hook 36 that connects to a lock 42 at a second end of the second body component 12′. The clip 32 may assist in maintaining a connection between the first body component 12 and the second body component 12′. The clip 32 may prevent the lock 42 from being biased to a location where the lock 42 is removable from the recess 40. The clip 32 may be positioned so that if the clip 32 is moved there is an indication that the first body component 12 may have been moved relative to the second body component 12′. The clip 32 may be plastically deformable so that once removed, the clip 32 cannot be deformed back to an original state.

Thus, as shown, the connection region 22 includes at least two fasteners 20 and 20′ to form a connection between the first body component 12 and the second body component 12′. The clip 32 may also act as a fastener to connect the first body component 12 to the second body component 12′. The fastener 20 may create a seal between the first body component 12 and the second body component 12′ so that fluids and debris cannot pass therethrough.

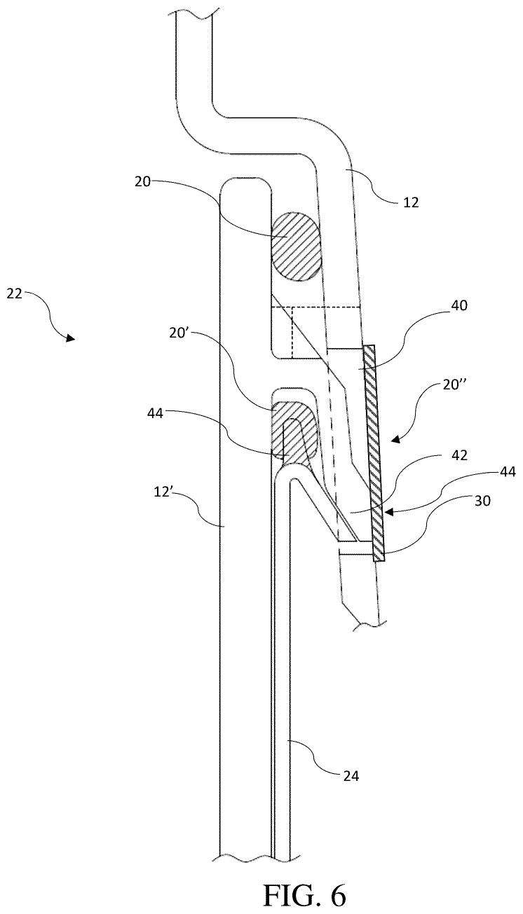

FIG. 6 is a cross-sectional view of a connection region 22. The connection region 22 is a location where a first body component 12 connects to a second body component 12′. A first fastener 20 is located between the first body component 12 and the second body component 12′ to create a first connecting force. A second fastener 20′ is located between the first body component 12 and the second body component 12′ to create a second connecting force.

The first body component 12 includes a recess 40. A lock 42 of the second body component 12′ extends into and through the recess 40 as a third fastener 20″ to form a third connecting force. A cover 24 connects to the second fastener 20′, the lock 42, or both. The cover 24 may include a cover lip 26. An indicating material 30 may connect to the first body component 12 and the second body component 12′. The indicating material 30 may connect to the lock 42 by an indicating lock 44. The indicating material 30 may be damaged or create an indication if the lock 42 is moved out of the recess 40 so that it is determinable if the connection region 22 is accessed.

Any numerical values recited herein include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner.

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The disclosures of all articles and references, including patent applications and publications, are incorporated by reference for all purposes. The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of or even consists of the elements, ingredients, components or steps.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

It is understood that the above description is intended to be illustrative and not restrictive. Many embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not consider such subject matter to be part of the disclosed inventive subject matter.

1. A light system comprising:
a first body component;
a second body component connected to the first body component forming a connection region;
an interior space located between the first body component and the second body component; and
one or more fasteners located within the connection region to connect the first body component to the second body component;
wherein at least one of the one or more fasteners is a seal, and the seal extends between and connects the first body component and the second body component together so that debris, fluids, or both are prevented from entering the light system;
wherein the seal is amorphous.

2. (canceled)

3. The light system of claim 1, wherein the seal is plastically deformable.

4. The light system of claim 1, wherein seal is hydrophobic, has a sufficient tackiness to prevent fluid from passing between the first body component and the second body component in the connection regions, or both.

5. The light system of claim 1, wherein the one or more seals prevent fluid, debris, or both from passing into the interior space.

6. The light system of claim 1, wherein the one or more fasteners include a first fastener that is a monolithic part of the first body component and a second fastener that is a monolithic part of the second fastener.

7. The light system of claim 6, wherein the first fastener is a recess that extends partly or completely through the first body component and the second fastener is a projection that extends through the recess to connect the first body component and the second body component together.

8. The light system of claim 1, further comprising:
an indicating material that extends along all or a portion of the connection region so that when the connection region is opened, the connection region is tampered with, the interior space is accessed, or a combination thereof the indicating material provides an indication.

9. The light system of claim 8, wherein the indication is a change in color, deformation, or both of the indicating material.

10. The light system of claim 1, wherein the one or more fasteners are a threaded member that extends between and connects the first body component to the second body component or a clip that connects the first body component to the second body component.

11. A light system comprising:
a first body component;
a second body component connected to the first body component forming a connection region;
an interior space located between the first body component and the second body component;
one or more fasteners located within the connection region to connect the first body component to the second body component; and
one or more indicating materials covering all or a portion of the connection region so that when the connection between the first component and the second component is removed the one or more indicating materials provide an indication.

12. The light system of claim 11, wherein the indication is that all or a portion of the one or more indicating materials have been removed or are missing.

13. The light system of claim 11, wherein the one or more indication materials cover the connection region so that the connection can only be accessed by altering the one or more indication materials to provide the indication.

14. The light system of claim 11, wherein the one or more fasteners is a seal with a tackiness that is sufficient to create a holding force to hold the first body component relative to the second body component.

15. The light system of claim 14, wherein the one or more fasteners include a hook on the first body component that holds the first body component in fixed communication with the second body component.

16. The light system of claim 11, wherein the one or more fasteners include a lock on the first body component that forms a one-way connection with the second body component.

17. The light system of claim 16, wherein the lock on the first body component extends through a recess in the second body component to form the one-way connection.

18. The light system of claim 17, wherein the lock extends through the recess and into an indicating lock in the one or more indicating materials so that the lock and the indicating lock are connected together and the lock cannot be moved back through the recess without causing the one or more indicating materials to provide the indication.

19. The light system of claim 11, wherein the one or more fasteners comprise a clip that comprises:
a first end with a tab that connects to a first side of the connection region and a second end with a hook that connects to a second side of the connection region so that the connection regions is closed by the clip.

20. A light system comprising:
a first body component;
a second body component connected to the first body component forming a connection region;
an interior space located between the first body component and the second body component;
one or more fasteners located within the connection region to connect the first body component to the second body component; and
one or more internal components located within the interior space;
wherein the one or more fasteners are free of forming a sealed connection between the first body component and the second body component and the one or more internal components are sealed.

21. The light system of claim 1, wherein the first body includes a recess and the second body includes a lock that extends through the recess to connect the first body and the second body together, wherein the fastener is located between a wall of the first body and the lock of the second body.
